(19) United States
(12) Patent Application Publication
(10) Pub. No.: US 2016/0378151 A1
(43) Pub. Date: Dec. 29, 2016

(54) RACK SCALE ARCHITECTURE (RSA) AND SHARED MEMORY CONTROLLER (SMC) TECHNIQUES OF FAST ZEROING

(71) Applicant: Intel Corporation, Santa Clara, CA (US)

(72) Inventors: Bruce Querbach, Hillsboro, OR (US); Mark A. Schmisseur, Phoenix, AZ (US); Raj K. Ramanujan, Federal Way, WA (US); Mohamed Arafa, Chandler, AZ (US); Christopher F. Connor, Hillsboro, OR (US); Sudeep Puligundla, Hillsboro, OR (US); Mohan J. Kumar, Aloha, OR (US)

(73) Assignee: Intel Corporation, Santa Clara, CA (US)

(21) Appl. No.: 14/752,826

(22) Filed: Jun. 26, 2015

(51) Int. Cl. G06F 1/26; G06F 3/06

(52) U.S. Cl. CPC G06F 1/26; G06F 3/0619; G06F 3/0652; G06F 3/0685

(57) ABSTRACT

Methods and apparatus related to Rack Scale Architecture (RSA) and/or Shared Memory Controller (SMC) techniques of fast zeroing are described. In one embodiment, a storage device stores meta data corresponding to a portion of a non-volatile memory. Logic, coupled to the non-volatile memory, causes an update to the stored meta data in response to a request for initialization of the portion of the non-volatile memory. The logic causes initialization of the portion of the non-volatile memory prior to a reboot or power cycle of the non-volatile memory. Other embodiments are also disclosed and claimed.

### FIELD

The present disclosure generally relates to the field of electronics. More particularly, some embodiments generally relate to Rack Scale Architecture (RSA) and/or Shared Memory Controller (SMC) techniques of fast zeroing.

### BACKGROUND

Generally, memory used to store data in a computing system can be volatile (to store volatile information) or non-volatile (to store persistent information). Volatile data structures stored in volatile memory are generally used for temporary or intermediate information that is required to support the functionality of a program during the run-time of the program. On the other hand, persistent data structures stored in non-volatile (or persistent memory) are available beyond the run-time of a program and can be reused. Moreover, new data is typically generated as volatile data first, before a user or programmer decides to make the data persistent. For example, programmers or users may cause mapping (i.e., instantiating) of volatile structures in volatile main memory that is directly accessible by a processor. Persistent data structures, on the other hand, are instantiated on non-volatile storage devices like rotating disks attached to Input/Output (I/O or IO) buses or non-volatile memory based devices like a solid state drive.

As computing capabilities are enhanced in processors, one concern is the speed at which memory may be accessed by a processor. For example, to process data, a processor may need to first fetch data from a memory. After completion of the data processing, the results may need to be stored in the memory. Therefore, the memory access speed can have a direct effect on overall system performance.

Another important consideration is power consumption. For example, in mobile computing devices that rely on battery power, it is very important to reduce power consumption to allow for the device to operate while mobile. Power consumption is also important for non-mobile computing devices as excess power consumption may increase costs (e.g., due to additional power usage, increased cooling requirements, etc.), shorten component life, limit locations at which a device may be used, etc.

Hard disk drives provide a relatively low-cost storage solution and are used in many computing devices to provide non-volatile storage. Disk drives, however, use a lot of power when compared with solid state drives since a hard disk drive needs to spin its disks at a relatively high speed and move disk heads relative to the spinning disks to read/write data. This physical movement generates heat and increases power consumption. Also, solid state drives are much faster at performing read and write operations when compared with hard drives. To this end, many computing segments are migrating towards solid state drives.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4-6 illustrate block diagrams of embodiments of computing systems, which may be utilized to implement various embodiments discussed herein.

FIG. 2 illustrates a block diagram of various components of a solid state drive, according to an embodiment.

FIG. 3A illustrates a block diagram of a Rack Scale Architecture (RSA), according to an embodiment.

FIG. 3B illustrates a block diagram of a high level architecture for a Shared

Memory Controller (SMC), according to an embodiment.

FIG. 3C illustrates flow diagrams of state machines for managing meta data, according to some embodiments.

FIGS. 3D1, 3D2, and 3D3 illustrate high level architectural view of various

SMC implementations in accordance with some embodiments.

FIGS. 3E and 3F illustrate block diagrams for extensions to RSA and/or SMC topology in accordance with some embodiments.

FIG. 3G illustrates a flow diagram of a method, in accordance with an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As cloud computing grows in the market place, a computer no longer consists of just a Central Processing Unit (CPU), memory, and hard disk. In the future, an entire rack or an entire server farm may include resources such as an array of CPU or processor (or processor core) nodes, a pool of memory, and a number of storage disks or units that are software configurable and Software Defined Infrastructure (SDI) depending on the workload. Hence, there is a need for utilization of Rack Scale Architecture (RSA).

As a part of the RSA, frequently cloud service providers provision the same server build many times across a server farm regardless of actual workload demand on the memory foot print. This can lead to a significant amount of server memory remaining unused in a cloud server farm, which can unnecessarily increase the cost for the service providers. In turn, a Shared Memory Controller (SMC) enables dynamic allocation and de-allocation of pooled memory that is software configurable. Through SMC, memory can be shared and pooled as a common resource in a server farm. This can reduce the unused memory foot print, and the overall cost of providing cloud server farms, and specifically memory costs, may significantly decrease.

Further, as a part of the SMC, when one node is done with its exclusive memory and before the memory can be reallocated to another node, the memory content must be cleared to zero (e.g., for security and/or privacy reasons). In other words, the cloud providers' policy do not generally allow neighboring virtual machine tenants to access data that does not belong to them. However, there is a problem with the time it takes for a large capacity of memory to be zeroed by today's methods (e.g., which utilize software for zeroing content). For example, with a Terra Byte (TB) of memory, writes to a NVM DIMM (Non-Volatile Memory Dual-Inline Memory Module) at 4 GB/s would be at about 250 sec/TB or 4 minutes, which can be an eternity in an enterprise computer system.

To this end, some embodiments relate to Rack Scale Architecture (RSA) and/or Shared Memory Controller (SMC) techniques for fast zeroing. In an embodiment, fast zeroing of memory content used with shared memory controller is provided across a pooled memory infrastructure. In another embodiment, memory expansion and/or scalability of large pools of memory are provided, e.g., up to 64 TB per SMC, and up to four SMCs cross connected, for example, to provide up to 256 TB of memory in a cloud server environment.

Furthermore, even though some embodiments are generally discussed with reference to Non-Volatile Memory (NVM), embodiments are not limited to a single type of NVM and non-volatile memory of any type or combinations of different NVM types (e.g., in a format such as a Solid State Drive (or SSD, e.g., including NAND and/or NOR type of memory cells) or other formats usable for storage such as a memory drive, flash drive, etc.) may be used. The storage media (whether used in SSD format or otherwise) can be any type of storage media including, for example, one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), etc. Also, any type of Random Access Memory (RAM) such as Dynamic RAM (DRAM), backed by a power reserve (such as a battery or capacitance) to retain the data, may be used. Hence, even volatile memory capable of retaining data during power failure or power disruption may be used for storage in various embodiments.

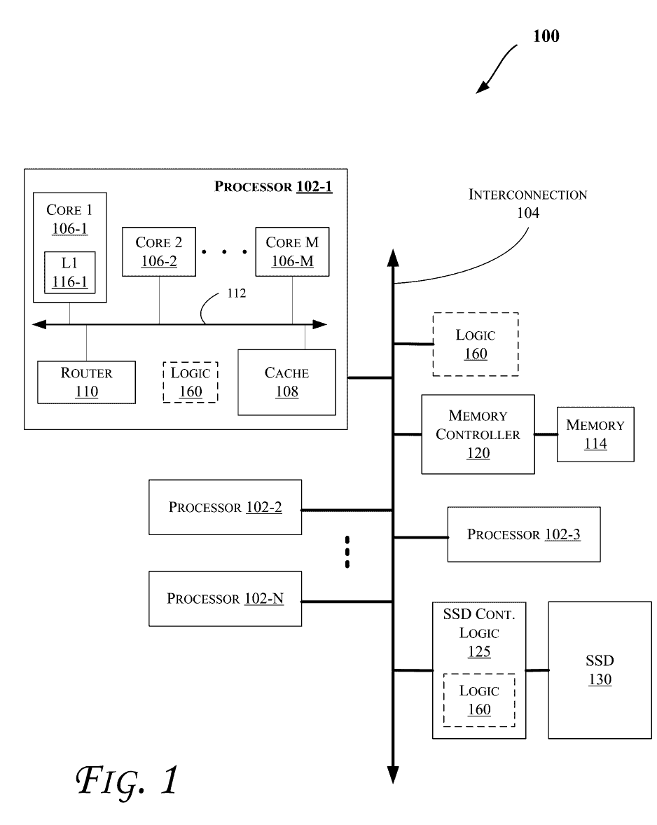

The techniques discussed herein may be provided in various computing systems (e.g., including a non-mobile computing device such as a desktop, workstation, server, rack system, etc. and a mobile computing device such as a smartphone, tablet, UMPC (Ultra-Mobile Personal Computer), laptop computer, Ultrabook™ computing device, smart watch, smart glasses, smart bracelet, etc.), including those discussed with reference to FIGS. 1-6. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

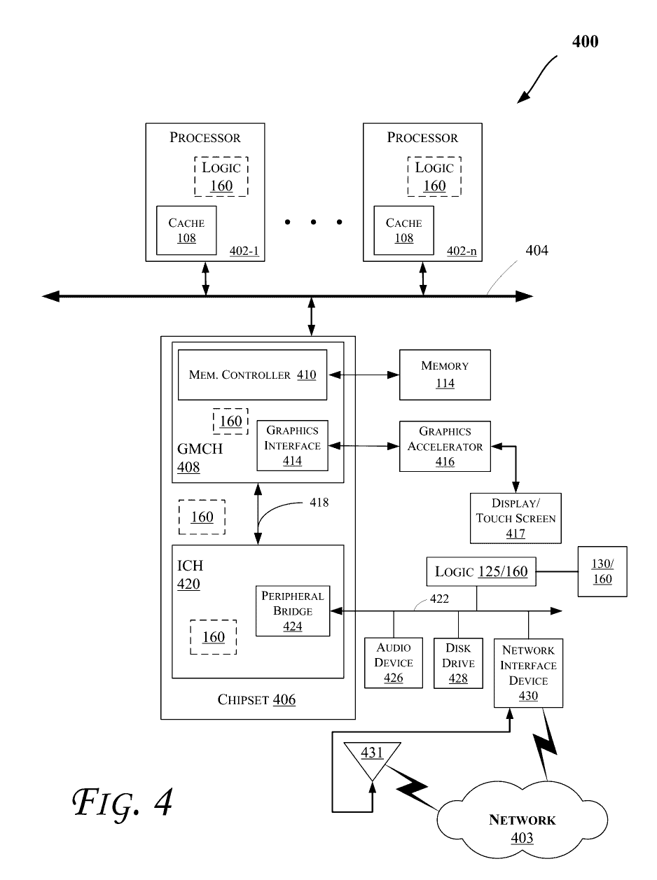

In an embodiment, the processor 102-1 may include one or more processor cores 106-1 through 106-M (referred to herein as “cores 106,” or more generally as “core 106”), a processor cache 108 (which may be a shared cache or a private cache in various embodiments), and/or a router 110. The processor cores 106 may be implemented on a single integrated circuit (IC) chip. Moreover, the chip may include one or more shared and/or private caches (such as processor cache 108), buses or interconnections (such as a bus or interconnection 112), logic 120, memory controllers (such as those discussed with reference to FIGS. 4-6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The processor cache 108 may store data (e.g., including instructions) that are utilized by one or more components of the processor 102-1, such as the cores 106. For example, the processor cache 108 may locally cache data stored in a memory 114 for faster access by the components of the processor 102. As shown in FIG. 1, the memory 114 may be in communication with the processors 102 via the interconnection 104. In an embodiment, the processor cache 108 (that may be shared) may have various levels, for example, the processor cache 108 may be a mid-level cache and/or a last-level cache (LLC). Also, each of the cores 106 may include a level 1 (L1) processor cache (116-1) (generally referred to herein as “L1 processor cache 116”). Various components of the processor 102-1 may communicate with the processor cache 108 directly, through a bus (e.g., the bus 112), and/or a memory controller or hub.

As shown in FIG. 1, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

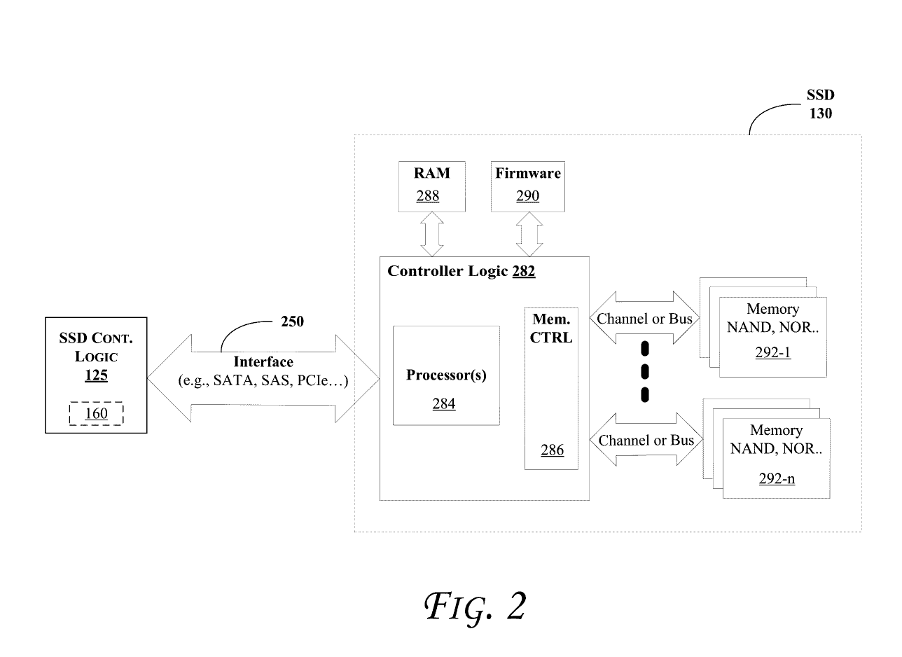

System 100 also includes Non-Volatile (NV) storage (or Non-Volatile Memory (NVM)) device such as an SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 1, logic 125 can alternatively communicate via a storage bus/interconnect (such as the SATA (Serial Advanced Technology Attachment) bus, Peripheral Component Interconnect (PCI) (or PCI express (PCIe) interface), etc.) with one or more other components of system 100 (for example where the storage bus is coupled to interconnect 104 via some other logic like a bus bridge, chipset (such as discussed with reference to FIGS. 2 and 4-6), etc.). Additionally, logic 125 may be incorporated into memory controller logic (such as those discussed with reference to FIGS. 4-6) or provided on a same Integrated Circuit (IC) device in various embodiments (e.g., on the same IC device as the SSD 130 or in the same enclosure as the SSD 130). System 100 may also include other types of non-volatile storage such as those discussed with reference to FIGS. 4-6, including for example a hard drive, etc.

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein such as those discussed with reference to other figures including 4-6, for example), including the cores 106, interconnections 104 or 112, components outside of the processor 102, SSD 130, SSD bus, SATA bus, logic 125, etc., to sense variations in various factors affecting power/thermal behavior of the system/platform, such as temperature, operating frequency, operating voltage, power consumption, and/or inter-core communication activity, etc.

As illustrated in FIG. 1, system 100 may include logic 160, which can be located in various locations in system 100 (such as those locations shown, including coupled to interconnect 104, inside processor 102, etc.). As discussed herein, logic 160 facilitates operation(s) related to some embodiments such as provision of RSA and/or SMC for fast zeroing.

FIG. 2 illustrates a block diagram of various components of an SSD, according to an embodiment. Logic 160 may be located in various locations in system 100 of FIG. 1 as discussed, as well as inside SSD controller logic 125. While SSD controller logic 125 may facilitate communication between the SSD 130 and other system components via an interface 250 (e.g., SATA, SAS, PCIe, etc.), a controller logic 282 facilitates communication between logic 125 and components inside the SSD 130 (or communication between components inside the SSD 130). As shown in FIG. 2, controller logic 282 includes one or more processor cores or processors 284 and memory controller logic 286, and is coupled to Random Access Memory (RAM) 288, firmware storage 290, and one or more memory modules or dies 292-1 to 292-n (which may include NAND flash, NOR flash, or other types of non-volatile memory). Memory modules 292-1 to 292-n are coupled to the memory controller logic 286 via one or more memory channels or busses. One or more of the operations discussed with reference to FIGS. 1-6 may be performed by one or more of the components of FIG. 2, e.g., processors 284 and/or controller 282 may compress/decompress (or otherwise cause compression/decompression) of data written to or read from memory modules 292-1 to 292-n. Also, one or more of the operations of FIGS. 1-6 may be programmed into the firmware 290. Furthermore, in some embodiments, a hybrid drive may be used instead of the SSD 130 (where a plurality of memory modules/media 292-1 to 292-n is present such as a hard disk drive, flash memory, or other types of non-volatile memory discussed herein). In embodiments using a hybrid drive, logic 160 may be present in the same enclosure as the hybrid drive.

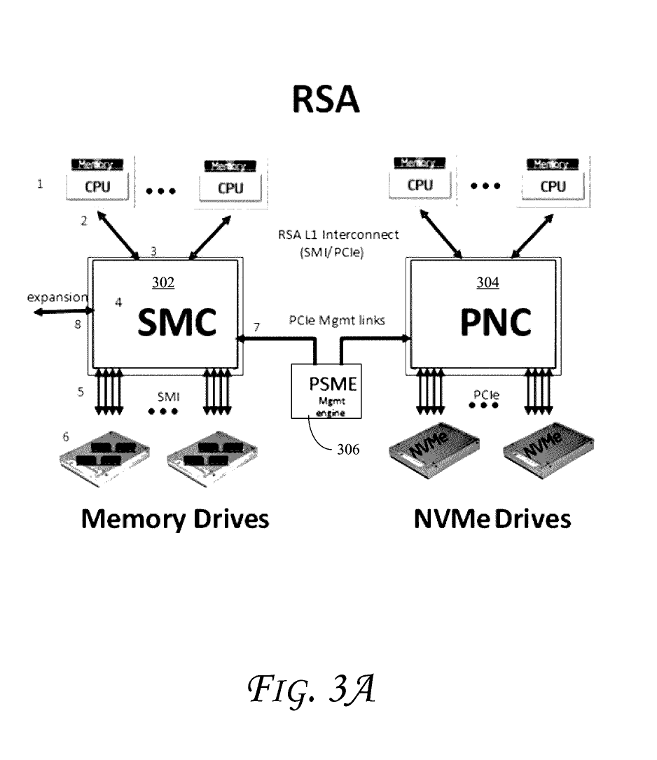

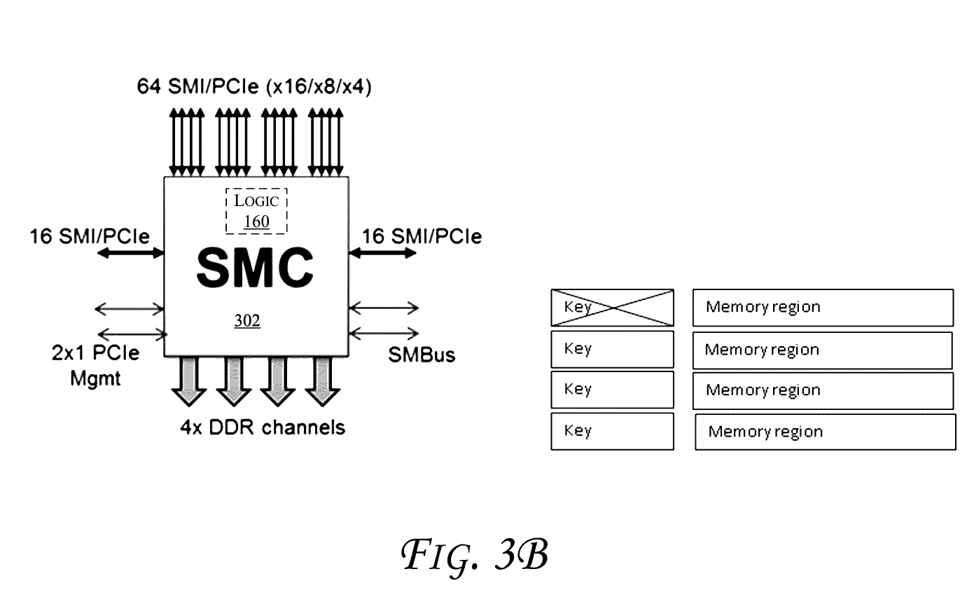

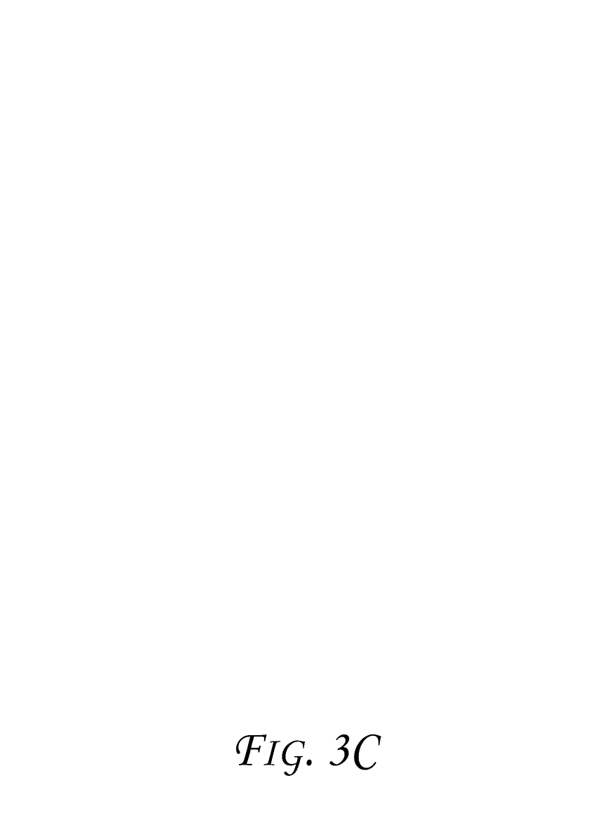

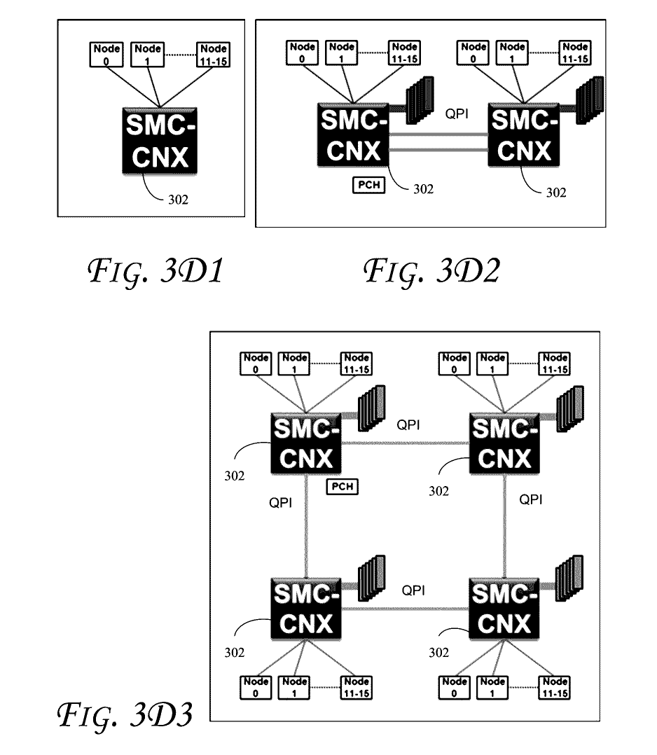

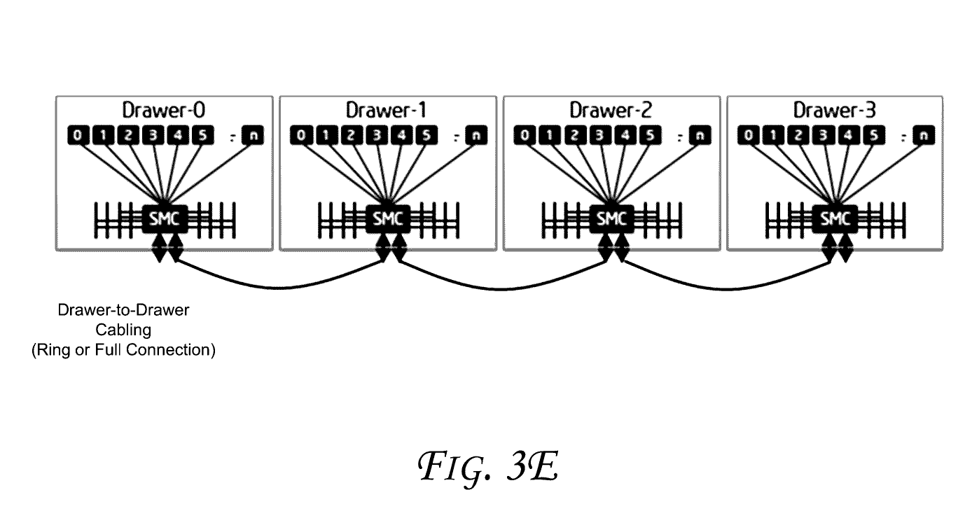

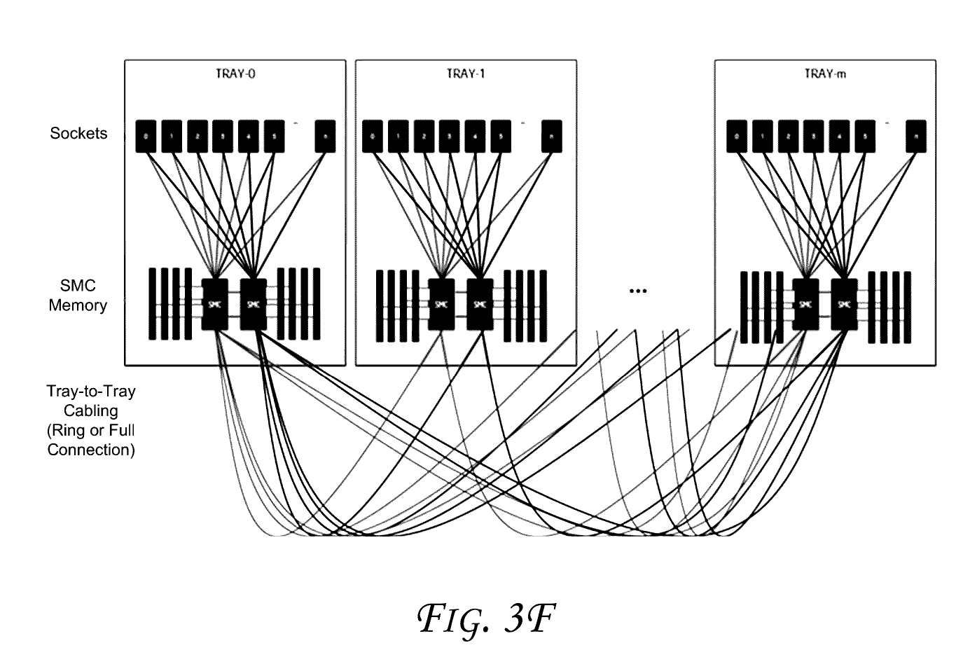

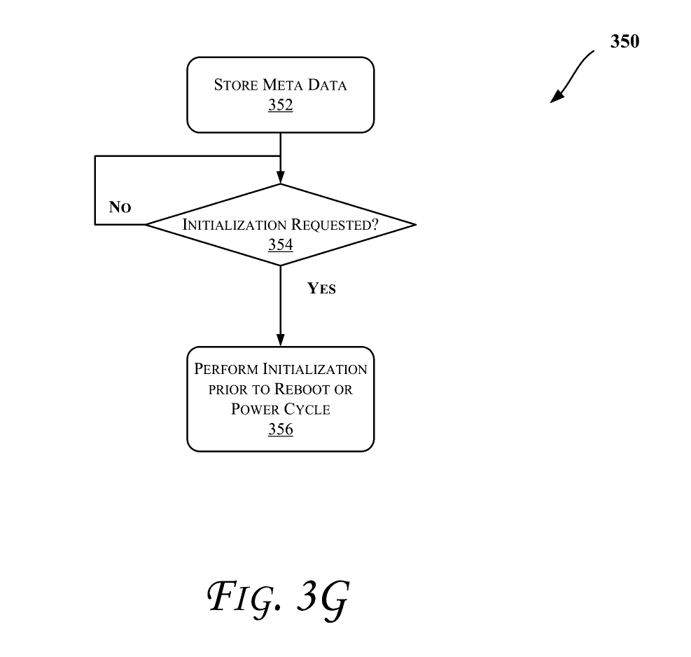

FIG. 3A illustrates a block diagram of an RSA architecture according to an embodiment. As shown in FIG. 3A, multiple CPUs (Central Processing Units, also referred to herein as “processors”), e.g., up to 16 nodes, can be coupled to a Shared Memory Controller (SMC) 302 via SMI (Shared Memory Interface) and/or PCIe (Peripheral Component Interconnect express) link(s) which are labeled as RSA L1 (Level 1) Interconnect in FIG. 3A. These links may be high speed links that support x2, x4, x8, and x16. Each CPU may have its own memory as shown (e.g., as discussed with reference to FIGS. 1 and 4-6). In an embodiment, SMC 302 can couple to up to four NVM Memory Drives (MD) via SMI, PCIe, DDR4 (Double Data Rate 4), and/or NVM DIMM (or NVDIMM) interfaces, although embodiments are not limited to four NVM MDs and more or less MDs may be utilized. In one embodiment, SMC 302 can couple to additional SMCs (e.g., up to four) in a ring topology. Such platform connectivity enables memory sharing and pooling across a much larger capacity (e.g., up to 256 TB). A variant of SMC silicon is called Pooled Network Controller (PNC) 304, in this case, with similar platform topology, PNC 302 is capable of coupling NVMe (or NVM express, e.g., in accordance with NVM Host Controller Interface Specification, revision 1.2, Nov. 3, 2014) drives via PCIe such as shown in FIG. 3A. As shown in FIG. 3A, a PSME (Pool System Management Engine) 306 may manage PCIe links for SMC 302 and/or PNC 304. In one embodiment, PSME is a RSA level management engine/logic for managing, allocating, and/or re-allocating resources at the rack level. It may be implemented using an x86 Atom™ processor core, and it runs RSA management software.

FIG. 3B illustrates a block diagram of a high level architecture for an SMC, according to an embodiment. In an embodiment, SMC 302 includes logic 160 to perform various operations discussed with reference to fast zeroing herein. The SMC 302 of FIG. 3B includes N number of upstream SMI/PCIe lanes (e.g., 64) to couple to the upstream nodes. It also includes N number of DDR4/NVDIMM memory channels (e.g., 4 or some other number, i.e., not necessarily the same number as the number of upstream lanes) to couple to pooled and shared memory. It may include an additional N number of SMI/PCIe lanes for expansion (e.g., 16 or 32, or some other number, i.e., not necessarily the same number as the afore-mentioned number of upstream lanes or memory channels), as well as miscellaneous JO (Input/Output) interfaces such as SMBus (System Management Bus) and PCIe management ports. Also, as shown, multiple keys or RV (Revision Version) may be used to support a unique key per memory region.

As discussed herein, SMC 302 introduces the concept of multiple memory regions that are independent. Each DIMM (Dual Inline Memory Module) or memory drive (or SSD, NVMe, etc.) may hold multiple memory regions. SMC manages these regions independently, so these regions may be private, shared, or pooled between nodes. Hence, some embodiments provide this concept of regions and fast zeroing of a region without affecting the whole DIMM or memory drive (or SSD, NVMe, etc.). The number of keys/revision numbers stored on (or otherwise stored in memory accessible to) the SMC for shared and pooled region is provided in an embodiment. Prior methods may include erasing or updating the key/revision number applied to a single CPU or system, e.g., worked at boot time only. In an embodiment, SMC is in a unique position to manage multiple DIMMs and configure/expose them as a shared or pooled memory region to the CPU nodes.

One embodiment allows for fast zeroing without a power cycle/reboot, which expands on existing method of NVM meta data and revision system to enable SMC to manage and to communicate with an NVM DIMM to update the meta data and revision number for multiple regions spanning across multiple DIMMs or memory drives (or SSD, NVMe, etc.).

Further, an embodiment provides partial range fast zeroing. To enable fast zeroing at a pool and shared memory region level, a power cycle or reboot of the NVM DIMM may be simulated without actual power cycle or reboot. Since some embodiments perform write operations directed to meta data, the transactions are far quicker than writing actual zeros to memory media.

Moreover, utilizing SMC provides a unique new platform memory architecture, and the ability to distribute the fast zeroing capability across NVM DIMM/controller, SMC, and/or CPU/processor nodes. In one embodiment, background fast zeroing is performed using meta data and revision numbers across multiple regions/DIMMs. SMC 302 may be provided inside a memory controller or scheduler (such as those discussed herein with reference to FIGS. 1-2 and/or 4-6) to offer hardware background memory “fast zeroing” capability. The “fast zeroing” operation may leverage existing NVM fast zeroing meta data and revision number, Current Version (CV) and Revision Version (RV). However, it extends the meta data and revision number beyond NVM DIMMs and into SMC (Shared Memory Controller) or MSP (Memory and Storage Processor), which offer per shared region fast zeroing, where zeroing one region does not affect the other regions, and fast zeroing does not require reboots.

Since the memory controller or scheduler (or logic 160 in some embodiments) is responsible for all memory transactions, the memory controller or scheduler can achieve fast zeroing via one or more of the following operations in some embodiments:

1. SMC (or logic 160) schedules one or more write operations to NVM DIMM meta data to increment the CV at the de-allocation of a memory region. This is equivalent to a reboot of NVN DIMM from NVM DIMM's fast zeroing version control perspective; thus, NVM DIMM is modified to support this command without reboot.

2. The memory region is marked (e.g., by logic 160) dirty/modified until all background write operations complete. A marked region may not be allocated until it is cleaned.

3. SMC 302 (or logic 160) allocates cleaned memory at the request from a node/processor/CPU to form a new pooled and shared region. If the revision number matches current version (e.g., as determined by logic 160), no revision updates is needed.

4. If the revision number of the new read request is not the same as revision number in the metadata stored (e.g., by logic 160), the read operation returns zeros (or some other indicator, e.g., by logic 160), and the background fast zeroing engine (or logic 160) updates the meta data, and stored data as a background process.

In some instances, a stall condition may exist. More particularly, in the case that requests for new pooled and shared region become too frequent and before enough memory is zeroed through writing meta data to NVM DIMM, the SMC 302 may have no choice but to stall the allocation of new pooled memory region. This may be rare though, since writing to NVM DIMM meta data is a relatively quick operation. For example, an MSP may track different and independent versions for each region through meta data. NVDIMM/SMI passes the version number as a part of meta data with each read request and write request. In turn, the NVM DIMM or MD (or memory controller or logic 160) may process or cause processing of these meta data accordingly.

FIG. 3C illustrates flow diagrams of state machines for managing meta data, according to some embodiments. For example, FIG. 3C shows how a meta data structure may be managed in the SMC/MSP chip. Meta data associated with each memory page indicates the page is either allocated or free. SMC/MSP actions such as “new partition” or “delete partition” are respectively shown by the lower state machine flow. When a page becomes “free”, it could be either “Clean” or “Dirty”. If it is “Dirty”, the background engine (e.g., logic 160) can zero the page, and update the meta data to indicate it is “clean”. Write commands can be followed by write data, which moves the meta data state from “Clean” to “Dirty”. The pages can stay “Dirty” until their partition is deleted.

Moreover, an embodiment may take advantage of encryption engine and capability built into x86 nodes/processors, where the SMC 302 (or logic 160) may improve performance by zeroing out memory quickly by updating key/revision number or schedule opportunistic background cycles through the memory controller/scheduler that does not impact functional bandwidth.

FIGS. 3D1, 3D2, and 3D3 illustrate high level architectural view of various SMC implementations in accordance with some embodiments. As shown, N number of upstream SMI/PCIe lanes (e.g., 64) may be present to couple to the upstream nodes. The architecture may include N number of DDR4/NVDIMM memory channels (e.g., four, or some other number) to couple to pooled and shared memory. An additional N number of SMI/PCIe lanes for expansion (e.g., 16 or 32, or some other number), as well as miscellaneous IOs such as SMBus and PCIe Management ports such as discussed with reference to FIG. 3B.

In the single SMC topology (FIG. 3D1), multiple nodes 0-15 are coupled to the SMC via SMI/PCIe link. SMI link uses PCIe physical layer (e.g., multiplexing memory protocol over PCIe physical layer). Up to 64 TB of SMC memory are directly mappable to any of the attached CPU nodes.

In the two SMC topology (FIG. 3D2), up to 128 TB of memory may be coupled to any individual node. Each SMC couples up to 16 nodes, thus up to 32 nodes are supported in this topology. Between the two SMCs, a dedicated QPI (Quick Path Interconnect) or SMI link provides high speed and low latency connectivity. Each SMC 302 examines the incoming memory read request and write request to determine if it is for the local SMC or for the remote SMC. If the traffic/request is for the remote SMC, the service agent of SMC (e.g., logic 16) routes the memory request to the remote SMC.

In the four SMC topology (FIG. 3D3), similar to the two SMC and one SMC topology, each SMC couples up to 16 CPU nodes. Up to 256 TB of memory are supported in this topology. Each SMC uses two QPI/SMI link to couple to each other in a ring topology. When a memory request is received at an SMC, the SMC determines if the request is for the local SMC or a remote SMC. The routing of remote traffic/request can follow a simple “pass to the right” (or pass to a next adjacent SMC in either direction) algorithm, as in if the request is not for the local, pass it to the SMC on the right/left. If the request is not local to the next SMC, the next SMC in turn passes the traffic to the next adjacent SMC on the right/left. In this topology, the maximum hop is three SMCs before the request becomes local. The return data may also follow to “pass to the right” (or pass to a next adjacent SMC in either direction) algorithm, and if it is not for the local SMC, the return data passes to the next SMC on the right/left. This routing algorithm enables a symmetric latency for requests to all remote memory that is not local to the SMC.

The ring topology may be physically applied to CPU/processor nodes that are stored in different drawers or trays, e.g., with the addition of PCIe over optics, the physical link distances may increase into hundreds of meters; hence, enabling the vision of a Rack Scale Architecture, where the entire rack or the entire server farm can be considered one giant computer, and memory pools are distributed across the computer farm. As discussed herein, RSA is defined such that a rack could be a single traditional physical rack, or multiple racks that expand a room or in different physical location, which are connected to form the “rack”. Also, a “drawer” or “tray” is generally defined as a physical unit of computing that are physically close to each other such as a 1U (1 Unit), 2U (2 Unit), 4U (4 Unit), etc. tray of computing resources that plugs into a rack. Communication within a drawer or tray may be considered short distance platform communication vs. rack level communication which could, for example, involve a fiber optics connection to another server location many miles away.

Additionally, the RSA and/or SMC topology may be extended to an arbitrary size (m) as shown in FIGS. 3E and 3F in accordance with some embodiments. When m number of trays are coupled together, more latency is involved since the maximum hop instead of three SMCs, now becomes m−1 if we follow the same simple ring topology as shown before with reference to FIGS. 3D2 and 3D3. To reduce the latency, extra physical links may be added between the different SMCs all the way up to a fully connected cross bar. In the case of fully connected cross bar, the latency may be reduced to maximum of one hop, but at the cost of increased physical connections (e.g., up to m−1).

Moreover, while there may have been memory expansion buffers that provide hardware and physical memory expansion, their expansion capability is generally low and certainly not as high as 256 TBs as discussed herein. These memory expansion solutions may typically enable one CPU node, which is very costly method of memory expansion. Further, without the sharing and pooling of this large capacity, most of the memory capacity is left unused, leading to further cost and limit large capacity build out of such systems.

Furthermore, some embodiments (e.g., involving RSA and/or SMC) can be widely used by the industry in data centers and cloud computing farms. Moreover, memory expansion to the above-discussed scale has generally not been possible due, e.g., to the extremely latency sensitive nature of memory technology. This is in part because many workloads' performance suffer significantly when the latency of access to memory increases. By contrast, some embodiments (with the above-discussed SMC approach to memory expansion) provide additional memory capacity (e.g., up to 256 TB) at reasonable latency (e.g., with a maximum of three hops); thus; enabling many workloads in the cloud/server farm computing environments.

FIG. 3G illustrates a flow diagram of a method 350, in accordance with an embodiment. In an embodiment, various components discussed with reference to the other figures may be utilized to perform one or more of the operations discussed with reference to FIG. 3G. In an embodiment, method 350 is implemented in logic such as logic 160. While various locations for logic 160 has been shown in FIGS. 4-7, embodiments are not limited to those and logic 160 may be provided in any location.

Referring to FIGS. 1-3G, at operation 352, meta data corresponding to a portion of a non-volatile memory is stored. An operation 354 determines whether an initialization request directed at the portion of the non-volatile memory has been received. If the request is received, operation 356 performs the initialization of the portion of the non-volatile memory (e.g., in the background or during runtime) prior to a reboot or power cycle of the non-volatile memory. The portion of the non-volatile memory may include memory across a plurality of shared non-volatile memory devices or across a plurality of shared memory regions. Also, the request for initialization of the portion of the non-volatile memory may cause zeroing of the portion of the non-volatile memory. In an embodiment, a plurality of shared memory controllers may be coupled in a ring topology.

FIG. 4 illustrates a block diagram of a computing system 400 in accordance with an embodiment. The computing system 400 may include one or more central processing unit(s) (CPUs) 402 or processors that communicate via an interconnection network (or bus) 404. The processors 402 may include a general purpose processor, a network processor (that processes data communicated over a computer network 403), an application processor (such as those used in cell phones, smart phones, etc.), or other types of a processor (including a reduced instruction set computer (RISC) processor or a complex instruction set computer (CISC)). Various types of computer networks 403 may be utilized including wired (e.g., Ethernet, Gigabit, Fiber, etc.) or wireless networks (such as cellular, including 3G (Third-Generation Cell-Phone Technology or 3rd Generation Wireless Format (UWCC)), 4G, Low Power Embedded (LPE), etc.). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

In an embodiment, one or more of the processors 402 may be the same or similar to the processors 102 of FIG. 1. For example, one or more of the processors 402 may include one or more of the cores 106 and/or processor cache 108. Also, the operations discussed with reference to FIGS. 1-3F may be performed by one or more components of the system 400.

A chipset 406 may also communicate with the interconnection network 404. The chipset 406 may include a graphics and memory control hub (GMCH) 408. The GMCH 408 may include a memory controller 410 (which may be the same or similar to the memory controller 120 of FIG. 1 in an embodiment) that communicates with the memory 114. The memory 114 may store data, including sequences of instructions that are executed by the CPU 402, or any other device included in the computing system 400. Also, system 400 includes logic 125, SSD 130, and/or logic 160 (which may be coupled to system 400 via bus 422 as illustrated, via other interconnects such as 404, where logic 125 is incorporated into chipset 406, etc. in various embodiments). In one embodiment, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk drive, flash, etc., including any NVM discussed herein. Additional devices may communicate via the interconnection network 404, such as multiple CPUs and/or multiple system memories.

The GMCH 408 may also include a graphics interface 414 that communicates with a graphics accelerator 416. In one embodiment, the graphics interface 414 may communicate with the graphics accelerator 416 via an accelerated graphics port (AGP) or Peripheral Component Interconnect (PCI) (or PCI express (PCIe) interface). In an embodiment, a display 417 (such as a flat panel display, touch screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display 417.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403, e.g., via a wired or wireless interface). As shown, the network interface device 430 may be coupled to an antenna 431 to wirelessly (e.g., via an Institute of Electrical and Electronics Engineers (IEEE) 802.11 interface (including IEEE 802.11a/b/g/n/ac, etc.), cellular interface, 3G, 4G, LPE, etc.) communicate with the network 403. Other devices may communicate via the bus 422. Also, various components (such as the network interface device 430) may communicate with the GMCH 408 in some embodiments. In addition, the processor 402 and the GMCH 408 may be combined to form a single chip. Furthermore, the graphics accelerator 416 may be included within the GMCH 408 in other embodiments.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

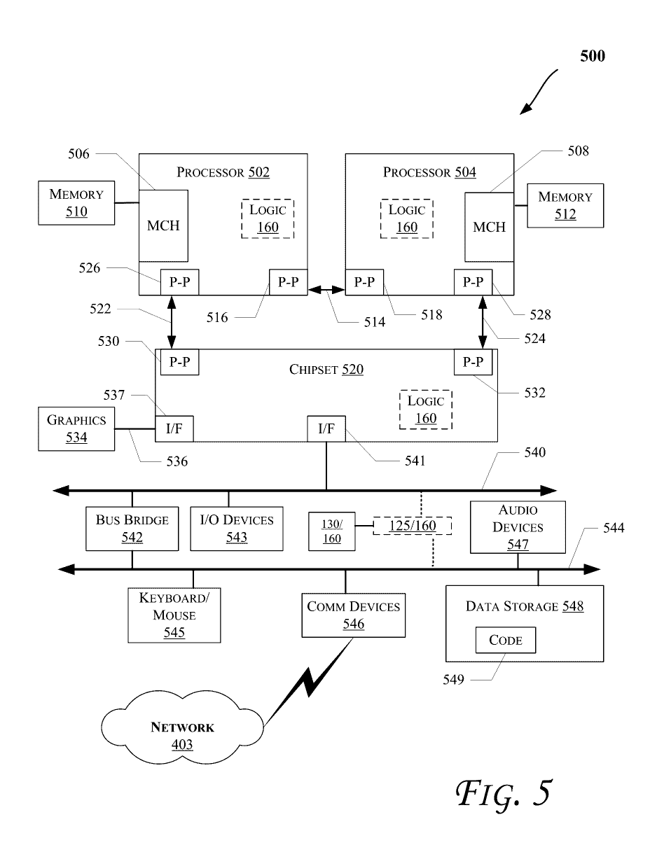

FIG. 5 illustrates a computing system 500 that is arranged in a point-to-point (PtP) configuration, according to an embodiment. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 114 of FIGS. 1 and/or 4. Also, MCH 506 and 508 may include the memory controller 120 in some embodiments. Furthermore, system 500 includes logic 125, SSD 130, and/or logic 160 (which may be coupled to system 500 via bus 540/544 such as illustrated, via other point-to-point connections to the processor(s) 502/504 or chipset 520, where logic 125 is incorporated into chipset 520, etc. in various embodiments).

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537. As discussed with reference to FIG. 4, the graphics interface 536 may be coupled to a display device (e.g., display 417) in some embodiments.

In one embodiment, one or more of the cores 106 and/or processor cache 108 of FIG. 1 may be located within the processors 502 and 504 (not shown). Other embodiments, however, may exist in other circuits, logic units, or devices within the system 500 of FIG. 5. Furthermore, other embodiments may be distributed throughout several circuits, logic units, or devices illustrated in FIG. 5.

The chipset 520 may communicate with a bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403, as discussed with reference to network interface device 430 for example, including via antenna 431), audio I/O device, and/or a data storage device 548. The data storage device 548 may store code 549 that may be executed by the processors 502 and/or 504.

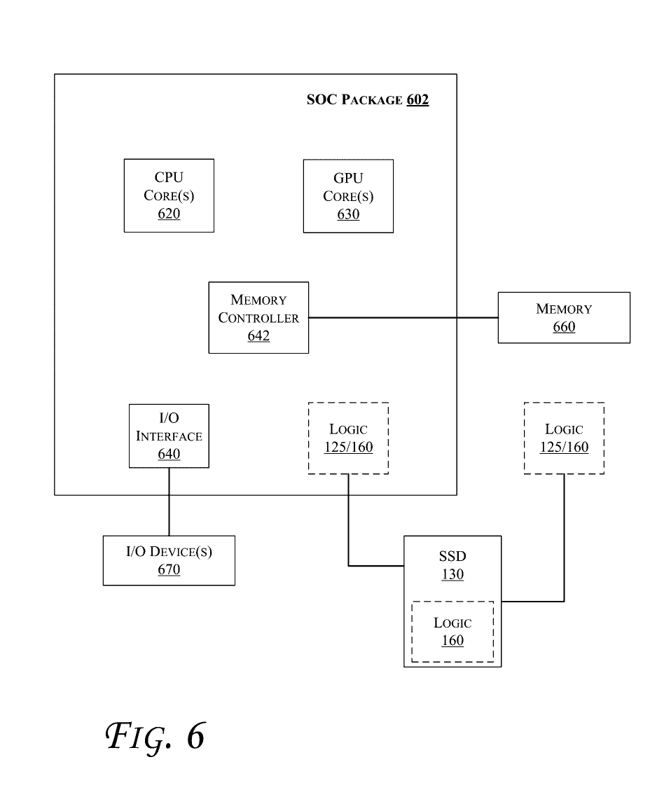

In some embodiments, one or more of the components discussed herein can be embodied as a System On Chip (SOC) device. FIG. 6 illustrates a block diagram of an SOC package in accordance with an embodiment. As illustrated in FIG. 6, SOC 602 includes one or more Central Processing Unit (CPU) cores 620, one or more Graphics Processor Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 620 may include one or more other components, e.g., as discussed with reference to the other figures herein. In one embodiment, SOC package 602 (and its components) is provided on one or more Integrated Circuit (IC) die, e.g., which are packaged onto a single semiconductor device.

As illustrated in FIG. 6, SOC package 602 is coupled to a memory 660 (which may be similar to or the same as memory discussed herein with reference to the other figures) via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display, an image/video capture device (such as a camera or camcorder/video recorder), a touch screen, a speaker, or the like. Furthermore, SOC package 602 may include/integrate the logic 125/160 in an embodiment. Alternatively, the logic 125/160 may be provided outside of the SOC package 602 (i.e., as a discrete logic).

The following examples pertain to further embodiments. Example 1 includes an apparatus comprising: a storage device to store meta data corresponding to a portion of a non-volatile memory; and logic, coupled to the non-volatile memory, to cause an update to the stored meta data in response to a request for initialization of the portion of the non-volatile memory, wherein the logic is to cause initialization of the portion of the non-volatile memory prior to a reboot or power cycle of the non-volatile memory. Example 2 includes the apparatus of example 1, wherein the portion of the non-volatile memory is to comprise memory across a plurality of shared non-volatile memory devices. Example 3 includes the apparatus of example 1, wherein the portion of the non-volatile memory is to comprise memory across a plurality of shared memory regions. Example 4 includes the apparatus of example 1, wherein the request for initialization of the portion of the non-volatile memory is to cause zeroing of the portion of the non-volatile memory. Example 5 includes the apparatus of example 1, wherein the logic is to operate in the background or during runtime to cause the update to the stored revision version number. Example 6 includes the apparatus of example 1, wherein the meta data is to comprise a revision version number and a current version number. Example 7 includes the apparatus of example 6, wherein the logic is cause the update by issuing one or more write operations to cause an update to the current version number. Example 8 includes the apparatus of example 7, wherein the one or more write operations are to cause the portion of the non-volatile memory to be marked as modified or dirty. Example 9 includes the apparatus of example 8, wherein the logic is to cause the portion of the non-volatile memory to be marked as clean in response to a shared memory allocation request by one or more processors. Example 10 includes the apparatus of example 1, wherein a shared memory controller is to comprise the logic. Example 11 includes the apparatus of example 10, wherein the shared memory controller is to couple one or more processors, each processor having one or more processor cores, to the non-volatile memory. Example 12 includes the apparatus of example 10, wherein the shared memory controller is to couple one or more processors, each processor having one or more processor cores, to a plurality of non-volatile memory devices. Example 13 includes the apparatus of example 1, wherein the non-volatile memory is to comprise the storage device. Example 14 includes the apparatus of example 1, wherein a shared memory controller is to have access to the storage device. Example 15 includes the apparatus of example 1, wherein a shared memory controller is to comprise the storage device. Example 16 includes the apparatus of example 1, further comprising a plurality of shared memory controllers, coupled in a ring topology, each of the plurality of shared memory controllers to comprise the logic. Example 17 includes the apparatus of example 1, wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), and volatile memory backed by a power reserve to retain data during power failure or power disruption. Example 18 includes the apparatus of example 1, further comprising a network interface to communicate the data with a host.

Example 19 includes a method comprising: storing, in a storage device, meta data corresponding to a portion of a non-volatile memory; and causing an update to the stored meta data in response to a request for initialization of the portion of the non-volatile memory, wherein the initialization of the portion of the non-volatile memory is to be performed prior to a reboot or power cycle of the non-volatile memory. Example 20 includes the method of example 19, wherein the portion of the non-volatile memory comprises memory across a plurality of shared non-volatile memory devices or across a plurality of shared memory regions. Example 21 includes the method of example 19, further comprising the request for initialization of the portion of the non-volatile memory causing zeroing of the portion of the non-volatile memory. Example 22 includes the method of example 19, further comprising causing the update to the stored revision version number to be performed in the background or during runtime. Example 23 includes the method of example 19, further comprising coupling a plurality of shared memory controllers in a ring topology.

Example 24 includes a computer-readable medium comprising one or more instructions that when executed on at least one processor configure the at least one processor to perform one or more operations to: store, in a storage device, meta data corresponding to a portion of a non-volatile memory; and cause an update to the stored meta data in response to a request for initialization of the portion of the non-volatile memory, wherein the initialization of the portion of the non-volatile memory is to be performed prior to a reboot or power cycle of the non-volatile memory. Example 25 includes the computer-readable medium of example 24, wherein the portion of the non-volatile memory comprises memory across a plurality of shared non-volatile memory devices or across a plurality of shared memory regions. Example 26 includes the computer-readable medium of example 24, further comprising one or more instructions that when executed on the at least one processor configure the at least one processor to perform one or more operations to cause zeroing of the portion of the non-volatile memory in response to the request for initialization of the portion of the non-volatile memory.

Example 27 includes a system comprising: a storage device to store meta data corresponding to a portion of a non-volatile memory; and a processor having logic, coupled to the non-volatile memory, to cause an update to the stored meta data in response to a request for initialization of the portion of the non-volatile memory, wherein the logic is to cause initialization of the portion of the non-volatile memory prior to a reboot or power cycle of the non-volatile memory. Example 28 includes the system of example 27, wherein the portion of the non-volatile memory is to comprise memory across a plurality of shared non-volatile memory devices. Example 29 includes the system of example 27, wherein the portion of the non-volatile memory is to comprise memory across a plurality of shared memory regions. Example 30 includes the system of example 27, wherein the request for initialization of the portion of the non-volatile memory is to cause zeroing of the portion of the non-volatile memory. Example 31 includes the system of example 27, wherein the logic is to operate in the background or during runtime to cause the update to the stored revision version number. Example 32 includes the system of example 27, wherein the meta data is to comprise a revision version number and a current version number. Example 33 includes the system of example 27, wherein a shared memory controller is to comprise the logic. Example 34 includes the system of example 27, wherein the non-volatile memory is to comprise the storage device. Example 35 includes the system of example 27, wherein a shared memory controller is to have access to the storage device. Example 36 includes the system of example 27, wherein a shared memory controller is to comprise the storage device. Example 37 includes the system of example 27, further comprising a plurality of shared memory controllers, coupled in a ring topology, each of the plurality of shared memory controllers to comprise the logic. Example 38 includes the system of example 27, wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), and volatile memory backed by a power reserve to retain data during power failure or power disruption. Example 39 includes the system of example 27, further comprising a network interface to communicate the data with a host.

Example 40 includes an apparatus comprising means to perform a method as set forth in any preceding example. Example 41 comprises machine-readable storage including machine-readable instructions, when executed, to implement a method or realize an apparatus as set forth in any preceding example.

In various embodiments, the operations discussed herein, e.g., with reference to FIGS. 1-6, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features, numerical values, and/or methodological acts, it is to be understood that claimed subject matter may not be limited to the specific features, numerical values, or acts described. Rather, the specific features, numerical values, and acts are disclosed as sample forms of implementing the claimed subject matter.

1. An apparatus comprising:
a storage device to store meta data corresponding to a portion of a non-volatile memory; and
logic, coupled to the non-volatile memory, to cause an update to the stored meta data in response to a request for initialization of the portion of the non-volatile memory,
wherein the logic is to cause initialization of the portion of the non-volatile memory prior to a reboot or power cycle of the non-volatile memory.

2. The apparatus of claim 1, wherein the portion of the non-volatile memory is to comprise memory across a plurality of shared non-volatile memory devices.

3. The apparatus of claim 1, wherein the portion of the non-volatile memory is to comprise memory across a plurality of shared memory regions.

4. The apparatus of claim 1, wherein the request for initialization of the portion of the non-volatile memory is to cause zeroing of the portion of the non-volatile memory.

5. The apparatus of claim 1, wherein the logic is to operate in the background or during runtime to cause the update to the stored revision version number.

6. The apparatus of claim 1, wherein the meta data is to comprise a revision version number and a current version number.

7. The apparatus of claim 6, wherein the logic is cause the update by issuing one or more write operations to cause an update to the current version number.

8. The apparatus of claim 7, wherein the one or more write operations are to cause the portion of the non-volatile memory to be marked as modified or dirty.

9. The apparatus of claim 8, wherein the logic is to cause the portion of the non-volatile memory to be marked as clean in response to a shared memory allocation request by one or more processors.

10. The apparatus of claim 1, wherein a shared memory controller is to comprise the logic.

11. The apparatus of claim 10, wherein the shared memory controller is to couple one or more processors, each processor having one or more processor cores, to the non-volatile memory.

12. The apparatus of claim 10, wherein the shared memory controller is to couple one or more processors, each processor having one or more processor cores, to a plurality of non-volatile memory devices.

13. The apparatus of claim 1, wherein the non-volatile memory is to comprise the storage device.

14. The apparatus of claim 1, wherein a shared memory controller is to have access to the storage device.

15. The apparatus of claim 1, wherein a shared memory controller is to comprise the storage device.

16. The apparatus of claim 1, further comprising a plurality of shared memory controllers, coupled in a ring topology, each of the plurality of shared memory controllers to comprise the logic.

17. The apparatus of claim 1, wherein the non-volatile memory is to comprise one or more of: nanowire memory, Ferro-electric Transistor Random Access Memory (FeTRAM), Magnetoresistive Random Access Memory (MRAM), flash memory, Spin Torque Transfer Random Access Memory (STTRAM), Resistive Random Access Memory, byte addressable 3-Dimensional Cross Point Memory, PCM (Phase Change Memory), and volatile memory backed by a power reserve to retain data during power failure or power disruption.

18. The apparatus of claim 1, further comprising a network interface to communicate the meta data with a host.

19. A method comprising:
storing, in a storage device, meta data corresponding to a portion of a non-volatile memory; and
causing an update to the stored meta data in response to a request for initialization of the portion of the non-volatile memory,
wherein the initialization of the portion of the non-volatile memory is to be performed prior to a reboot or power cycle of the non-volatile memory.

20. The method of claim 19, wherein the portion of the non-volatile memory comprises memory across a plurality of shared non-volatile memory devices or across a plurality of shared memory regions.

21. The method of claim 19, further comprising the request for initialization of the portion of the non-volatile memory causing zeroing of the portion of the non-volatile memory.

22. The method of claim 19, further comprising causing the update to the stored revision version number to be performed in the background or during runtime.

23. The method of claim 19, further comprising coupling a plurality of shared memory controllers in a ring topology.

24. A computer-readable medium comprising one or more instructions that when executed on at least one a processor configure the at least one processor to perform one or more operations to:
store, in a storage device, meta data corresponding to a portion of a non-volatile memory; and
cause an update to the stored meta data in response to a request for initialization of the portion of the non-volatile memory.
wherein the initialization of the portion of the non-volatile memory is to be performed prior lo a reboot or power cycle of the non-volatile memory.

25. The computer-readable medium of claim 24, wherein the portion of the non-volatile memory comprises memory across a plurality of shared non-volatile memory devices or across a plurality of shared memory regions.

26. The computer-readable medium of claim 24, further comprising one or more instructions that when executed on the at least one processor configure the at least one processor to perform one or more operations to cause zeroing of the portion of the non-volatile memory in response to the request for initialization of the portion of the non-volatile memory.
